(19) United States
(12) Patent Application Publication
(10) Pub. No.: US 2025/0374042 A1
(43) Pub. Date: Dec. 4, 2025

(54) SECURITY IN A DISTRIBUTED NAS TERMINATIONS ARCHITECTURE

(71) Applicant: Nokia Technologies Oy, Espoo (FI)

(72) Inventors: Martin MCGRATH, Dallas, TX (US); Devaki CHANDRAMOULI, Dallas, TX (US)

(21) Appl. No.: 19/102,732

(22) PCT Filed: Aug. 10, 2022
(86) PCT No.: PCT/US2022/074770

§ 371 Date: Feb. 10, 2025

(51) Int. Cl. H04W 12/0433; H04W 12/041; H04W 12/72

(52) U.S. Cl. CPC H04W 12/0433; H04W 12/041; H04W 12/72

(57) ABSTRACT

Various embodiments provide methods and apparatus for security in a distributed NAS terminations architecture. In an embodiment, a method performed by a terminal device comprises: generating an anchor key; receiving an anchor key identifier for the anchor key; deriving a set of non-access stratum, NAS, parent keys based on the anchor key, a subscription identifier and NAS indicators indicating different NAS procedures; and obtaining, for each of the set of NAS parent keys, a NAS parent key identifier.

### TECHNICAL FIELD

Embodiments of the present disclosure generally relate to wireless communication, and more particularly, to methods and apparatuses for security in a distributed NAS terminations architecture.

### BACKGROUND

In 5G System Architecture, as defined in 3GPP TS23.501, a non-access stratum (NAS) connection for a user equipment (UE) is always terminated in the serving network at a single network function (NF), e.g. access and mobility management function (AMF), as shown in FIG. 1. The NAS connection is integrity and confidentiality protected by means of a security procedure that is executed between the UE and the NF which establishes a NAS security context that is maintained by both the UE and the NF for the lifetime of the NAS connection. This NAS security context includes, among other parameters, the security keys and algorithms used to protect the NAS connection.

In a distributed NAS terminations architecture on the other hand, a UE may have multiple NAS connections which are terminated in the serving network at multiple different NFs. That is, the NAS connections are distributed across different NFs depending on NAS procedures that the NAS connections are supporting, as shown in FIG. 2. As an example, the UE may have two NAS connections terminated at two different NFs, one NAS connection carrying NAS mobility management procedure and being terminated at NF1, and the other NAS connection carrying NAS session management procedure and being terminated at NF2.

### SUMMARY

This summary is provided to introduce simplified concepts of subnetwork configuration and procedures to enable subnetwork operations, particularly on subnetwork identities. This summary is not intended to identify key features or essential features of the claimed subject matter, nor is it intended to be used to limit the scope of the claimed subject matter.

According to a first aspect of the disclosure, there is provided a terminal device. The terminal device comprises at least one processor and at least one memory storing instructions that, when executed by the at least one processor, cause the terminal device at least to: generate an anchor key; receive an anchor key identifier for the anchor key; derive a set of NAS parent keys based on the anchor key, a subscription identifier and NAS indicators indicating different NAS procedures; and obtain, for each of the set of NAS parent keys, a NAS parent key identifier.

According to a second aspect of the disclosure, there is provided a network entity configured to implement security key management function (SKMF). The network entity comprises at least one processor and at least one memory storing instructions that, when executed by the at least one processor, cause the network entity at least to: generate an anchor key with a terminal device; derive an anchor key identifier for the anchor key, and send the anchor key identifier to the terminal device; derive a set of NAS parent keys based on the anchor key, a subscription identifier and NAS indicators indicating different NAS procedures; and derive, for each of the set of NAS parent keys, a NAS parent key identifier based on the respective NAS indicator.

According to a third aspect of the disclosure, there is provided a core network entity configured to implement a core network function. The core network entity comprises at least one processor and at least one memory storing instructions that, when executed by the at least one processor, cause the network entity at least to: receive from a terminal device a request for establishment of a NAS connection carrying a NAS procedure between the terminal device and the core network entity; and obtain a NAS key for the NAS connection, wherein the NAS key is a NAS parent key or a NAS child key associated with a NAS indicator indicating the NAS procedure.

According to a fourth aspect of the disclosure, there is provided a method performed by a terminal device. The method comprises: generating an anchor key; receiving an anchor key identifier for the anchor key; deriving a set of non-access stratum, NAS, parent keys based on the anchor key, a subscription identifier and NAS indicators indicating different NAS procedures; and obtaining, for each of the set of NAS parent keys, a NAS parent key identifier.

According to a fifth aspect of the present disclosure, there is provided a method performed by a network entity configured to implement security key management function (SKMF). The method comprises: generating an anchor key with a terminal device; deriving an anchor key identifier for the anchor key, and sending the anchor key identifier to the terminal device; deriving a set of non-access stratum, NAS, parent keys based on the anchor key, a subscription identifier and NAS indicators indicating different NAS procedures; and deriving, for each of the set of NAS parent keys, a NAS parent key identifier based on the respective NAS indicator.

According to a sixth aspect of the present disclosure, there is provided a method performed by a core network entity configured to implement a core network function. The method comprises: receiving from a terminal device a request for establishment of a NAS connection carrying a NAS procedure between the terminal device and the core network entity; and obtaining a NAS key for the NAS connection, wherein the NAS key is a NAS parent key or a NAS child key associated with a NAS indicator indicating the NAS procedure.

According to a seventh aspect of the present disclosure, there is provided a terminal device. The terminal device comprises means for performing steps of any method according to the fourth aspect.

According to an eighth aspect of the present disclosure, there is provided a network entity configured to implement security key management function (SKMF). The network entity comprises means for performing steps of any method according to the fifth aspect.

According to a ninth aspect of the present disclosure, there is provided a core network entity configured to implement a core network function. The core network entity comprises means for performing steps of any method according to the sixth aspect.

According to a tenth aspect of the present disclosure, it is provided a computer readable storage medium, on which instructions are stored, when executed by at least one processor, the instructions cause the at least one processor to perform any method according to the fourth or fifth or sixth aspect.

According to an eleventh aspect of the present disclosure, it is provided a computer program product comprising instructions which when executed by at least one processor, cause the at least one processor to perform any method according to the fourth or fifth or sixth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings in which:

FIG. 1 illustrates an example of a single NAS termination in the 5G system architecture;

FIG. 2 illustrates an example of the distributed NAS terminations architecture;

FIG. 3 illustrates an example of a key hierarchy for the distributed NAS terminations architecture according to some embodiments of the present disclosure;

FIG. 4 illustrates another example of a key hierarchy for the distributed NAS terminations architecture according to some embodiments of the present disclosure;

FIG. 5 illustrates yet another example of a key hierarchy for the distributed NAS terminations architecture according to some embodiments of the present disclosure;

FIG. 6 illustrates still another example of a key hierarchy for the distributed NAS terminations architecture according to some embodiments of the present disclosure;

FIG. 7 is an exemplary call flow for securing multiple NAS connections according to some embodiments of the present disclosure;

FIG. 8 illustrates a security architecture for the distributed NAS terminations architecture according to some embodiments of the present disclosure;

FIG. 9 illustrates a security framework for the distributed NAS terminations architecture according to some embodiments of the present disclosure;

FIG. 10 is another exemplary call flow for securing multiple NAS connections according to some embodiments of the present disclosure;

FIG. 11 is a flow chart depicting a method for security in the distributed NAS terminations architecture according to some embodiments of the present disclosure;

FIG. 12 is a flow chart depicting a method for security in the distributed NAS terminations architecture according to some embodiments of the present disclosure;

FIG. 13 is a flow chart depicting a method for security in the distributed NAS terminations architecture according to some embodiments of the present disclosure; and

FIG. 14 shows a simplified block diagram of an apparatus according to some embodiments of the present disclosure.

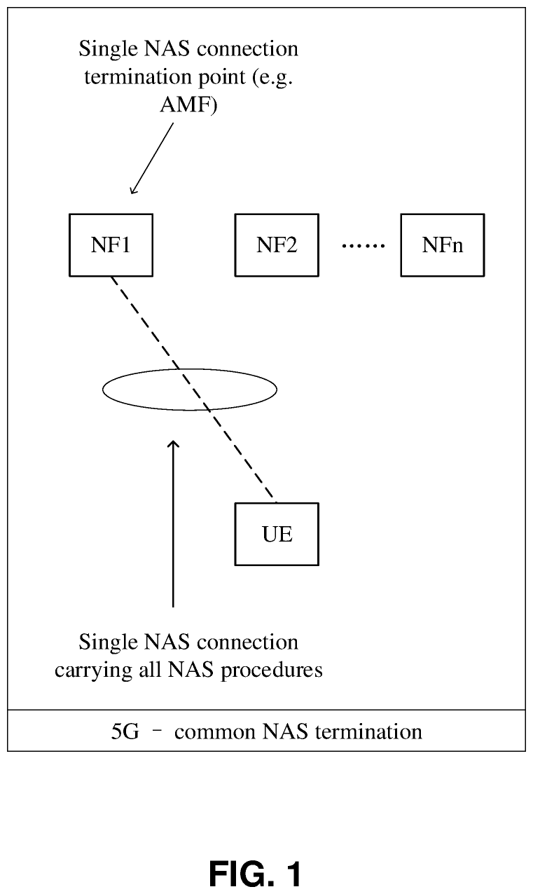

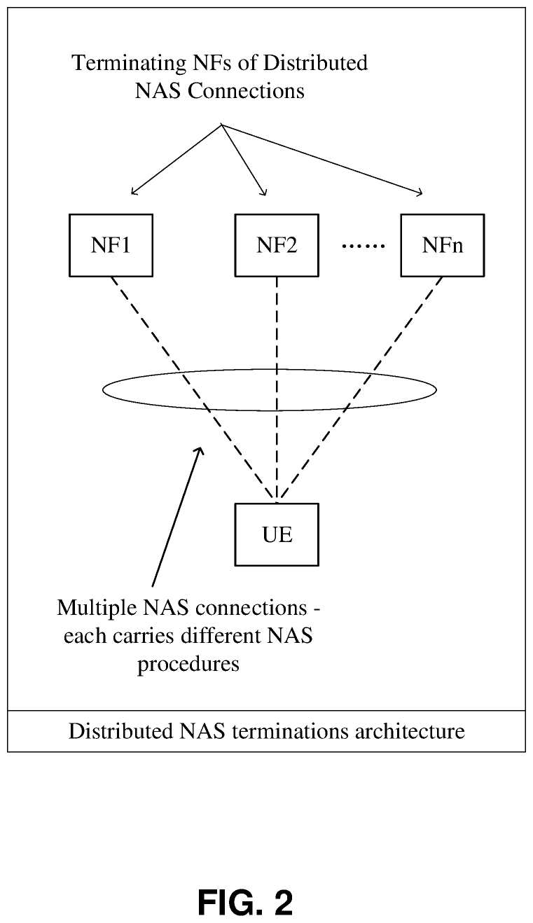

### DETAILED DESCRIPTION

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout.

In the following description and claims, unless defined otherwise, all technical and scientific terms used herein have the same meaning as commonly understood by one of ordinary skills in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of “circuitry” applies to all uses of this term in this application, including in any claims. As a further example, as used in this application, the term “circuitry” also covers an implementation of merely a hardware circuit or processor (or multiple processors) or portion of a hardware circuit or processor and its (or their) accompanying software and/or firmware. The term “circuitry” also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), New Radio (NR) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, 5G, the future sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any end device that can access a communication network and receive services therefrom. By way of example and not limitation, the terminal device may refer to a user equipment (UE) which may be a combination of a Universal Integrated Circuit Card (UICC)/Subscriber Identity Module (SIM) Card and a mobile equipment (ME), or other suitable devices. In the following description, the terms “terminal device”, “user equipment” and “UE” may be used interchangeably.

As used herein, the term “network entity” refers to any entity for supporting a network function in a communication network. The network entity can be implemented in a physical network node, or in a virtual network node which perform a function by logical resources in more than one physical network node.

As mentioned above, the 5G system architecture defines in 3GPP specifications (e.g. TS 23.501/23.502/24.501/33.501) how security is achieved for a single NAS connection between a UE and a single NF. However, no solution is defined to achieve security for multiple NAS connections of a distributed NAS terminations architecture.

Thus, various embodiments of the present disclosure describe a framework to secure the NAS connections of the distributed NAS terminations architecture. Specifically, the framework provides a mechanism for derivation and distribution of shared secret keys and associated key identifiers used to secure the NAS connections established between the UE and the terminating NFs.

Firstly, a key hierarchy for the distributed NAS termination architecture is described. To aid in the description, an analogy to a subset of the current 5G architecture key hierarchy is provided where the terms “anchor key” and “NAS parent key” are analogous to Kseaf and Kamf respectively. However, multiple NAS parent keys exist where Kamf can be considered as one NAS parent key. The NAS parent keys provide key separation for NAS connections carrying different NAS procedures such as NAS mobility management procedures, NAS session management procedures, NAS UE policy management procedures and so on.

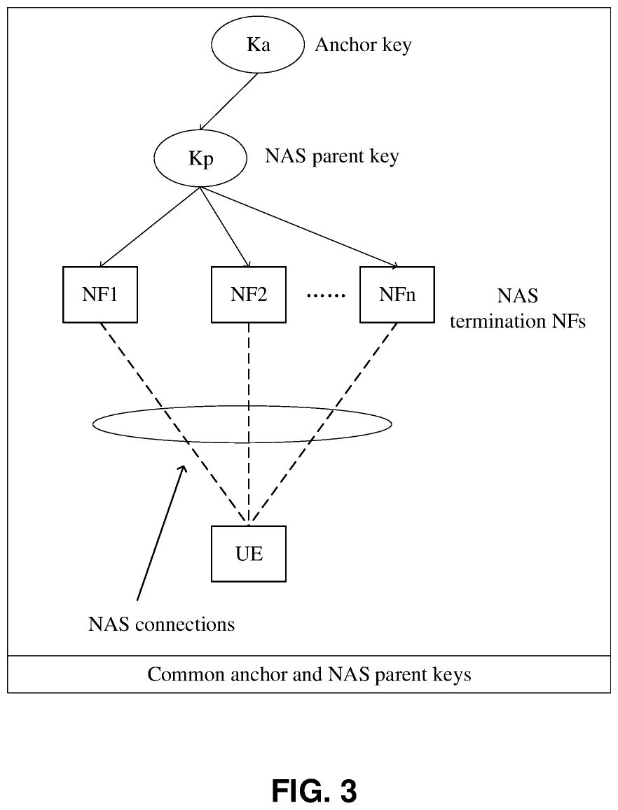

FIG. 3 illustrates an example of the key hierarchy for the distributed NAS terminations architecture (Option 1) according to some embodiments of the present disclosure, which includes a common anchor key and a common NAS parent key. Referring to FIG. 3, a single anchor key Ka is established by means of an authentication and key agreement (AKA) procedure, which is common to all NAS connections. This anchor key Ka is equivalent to Kseaf key in the current 5G architecture key hierarchy. A single NAS parent key Kp is derived from the common anchor key Ka which is common to all NAS connections. This approach requires a single AKA procedure run irrespective of the number of NAS connections.

Option 1 is closely aligned with the current 5G architecture key hierarchy, However, it has a number of drawbacks when it is applied to the distributed NAS terminations architecture: a) since the same NAS parent key Kp is used across different NAS connections, it can increase the attack surface and weaken NAS security especially with multiple NAS termination points; and b) the same NAS parent key Kp needs to be distributed to multiple NFs, which increases the attack surface compared to 5G and weakens NAS security.

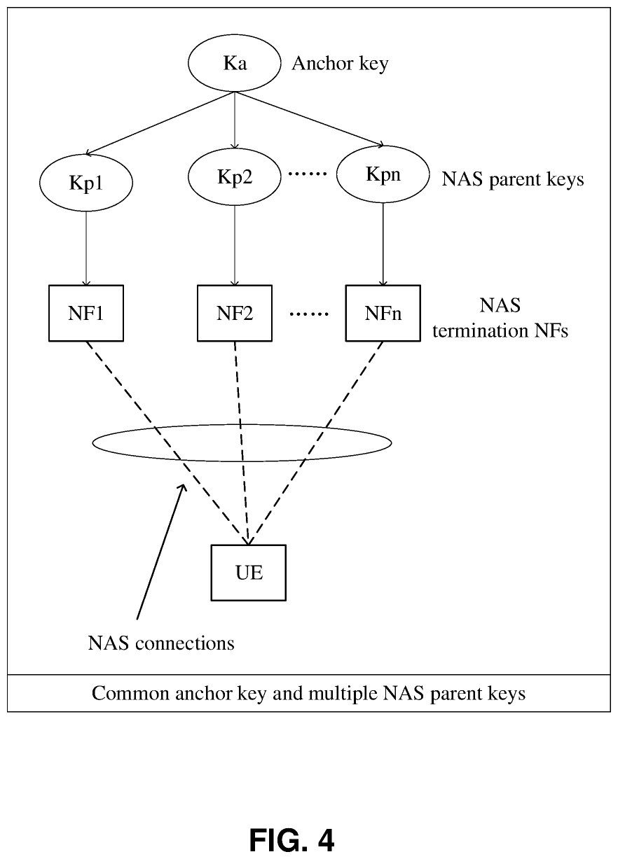

FIG. 4 illustrates another example of the key hierarchy for the distributed NAS terminations architecture (Option 2) according to some embodiments of the present disclosure, which includes a common anchor key Ka and multiple NAS parent keys, Kp1, Kp2 . . . Kpn. Referring to FIG. 4, an anchor key Ka is established by means of an AKA procedure, which is common to all NAS connections. This anchor key Ka is equivalent to Kseaf key in the current 5G architecture key hierarchy. Multiple NAS parent keys Kp1, Kp2 . . . Kpn are derived from this common anchor key Ka for each NAS connection. This approach requires a single AKA procedure run irrespective of the number of NAS connections.

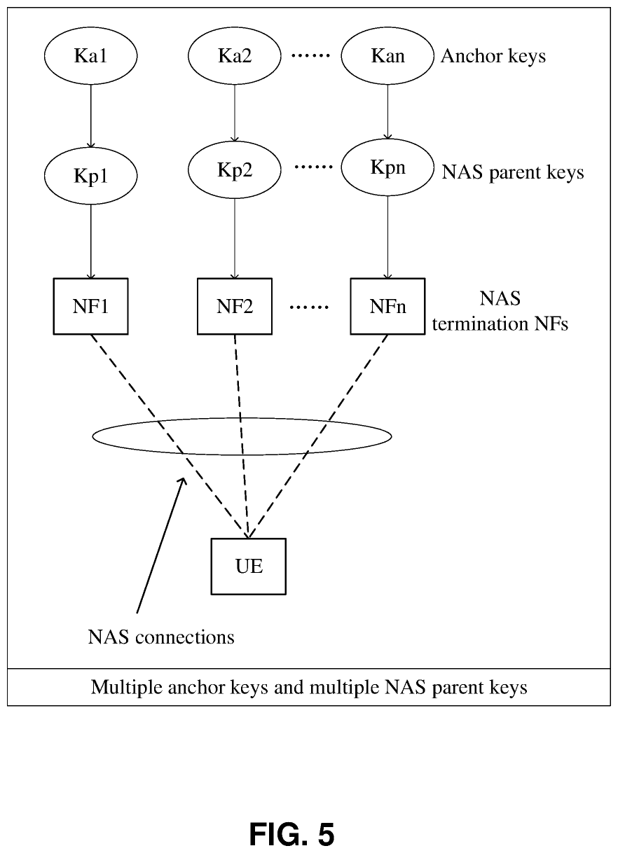

FIG. 5 illustrates yet another example of the key hierarchy for the distributed NAS terminations architecture (Option 3) according to some embodiments of the present disclosure, which includes multiple anchor keys and multiple NAS parent keys. Referring to FIG. 5, multiple anchor keys Ka1, Ka2, . . . Kan are established by means of an AKA procedure, one for each NAS connection. These anchor keys Ka1, Ka2, . . . Kan are equivalent to multiple unique Kseaf keys derived from a Kausf key in the current 5G architecture key hierarchy. A NAS parent key is derived from each anchor key for each NAS connection. As shown in FIG. 5, the NAS parent key Kp1 is derived from the anchor key Ka1, the NAS parent key Kp2 is derived from the anchor key Ka2, and the NAS parent key Kpn is derived from the anchor key Kan. This approach requires an AKA procedure run for each NAS connection.

Option 2 and Option 3 propose to use multiple NAS parent keys which provide unique shared secrets keys per NAS connection, and hence offer better NAS security compared to Option 1 which has the common NAS parent key for all NAS connections.

Option 3 may be considered to offer the most robust security in that each NAS connection has its own anchor key and NAS parent key derived from an AKA run. However, Option 3 requires the AKA procedure to run and signal with the home network each time a new NAS connection is established, which can hinder performance of the NAS procedures. Furthermore, it also brings impacts to the home network NF (e.g. authentication function (AUSF), unified data management (UDM), unified data repository (UDR)) as well as the UE (e.g. universal integrated circuit card (UICC), mobile equipment (ME)) to derive, store and manage multiple anchor keys.

Option 2 also supports multiple NAS parent keys, but due to the common anchor key it requires only a single AKA procedure for multiple NAS connections and does not have any impact on the home network NF (e.g. AUSF, UDM, UDR). As such, Option 2 is considered as the most optimal key hierarchy for the distributed NAS terminations architecture and will be elaborated later. Moreover, the following description will be described in the context of Option 2, and will also be applicable to Option 3.

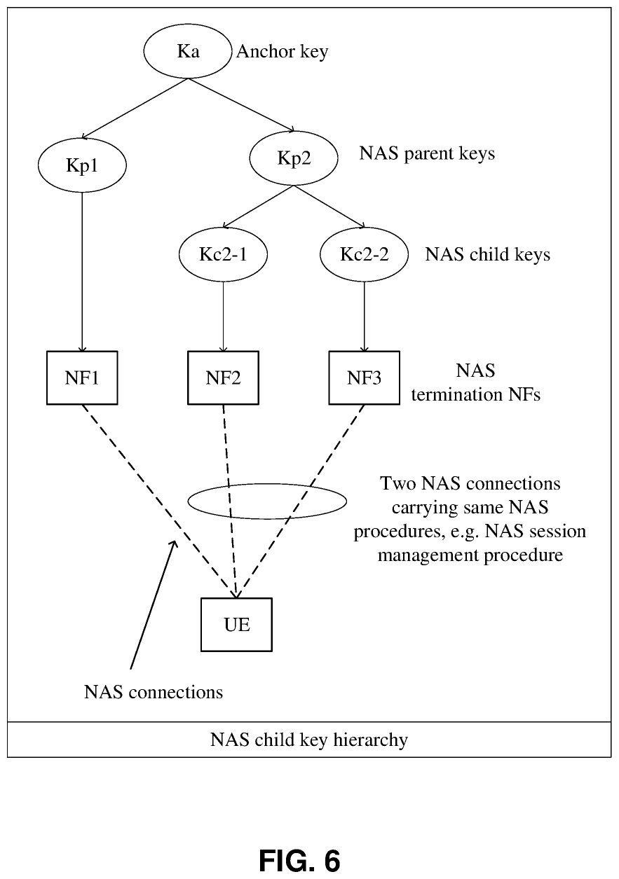

FIG. 6 illustrates still another example of the key hierarchy for the distributed NAS terminations architecture according to some embodiments of the present disclosure, in which a NAS child key is proposed in addition to the common anchor key Ka and multiple NAS parent keys e.g. Kp1, Kp2. While the NAS parent keys provide key separation for NAS connections carrying different NAS procedures, the NAS child keys provide key separation for NAS connections carrying the same NAS procedure, for instance NAS session management procedures. A UE may have two NAS protocol data unit (PDU) sessions, and hence have two NAS connections belonging to different network slices each slice having different security requirements. As shown in FIG. 6, the NAS child keys Kc2-1 and Kc2-2 are derived from the NAS parent key Kp2 for the two NAS connections. The NAS child keys provide key separation between these two NAS connections. Note that, the NAS child key applies predominantly to NAS session management procedures, but its use is not precluded for other NAS procedures.

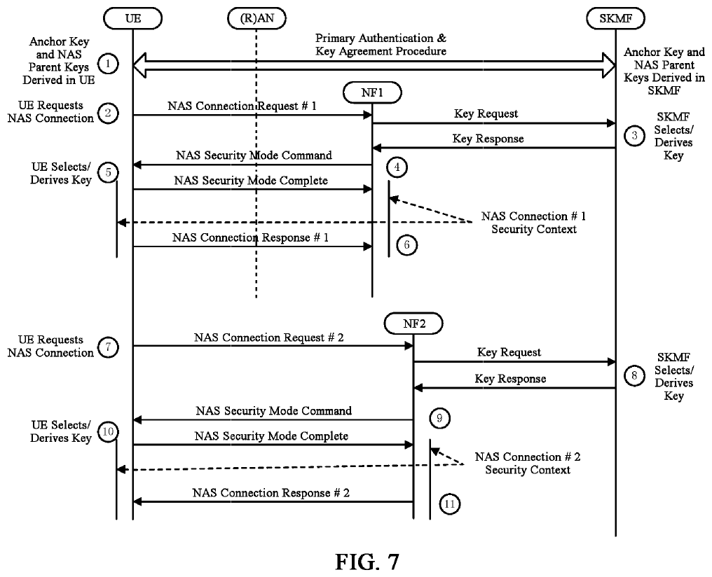

FIG. 7 is an exemplary call flow for securing multiple NAS connections according to some embodiments of the present disclosure, which depicts a scenario where a UE is registered in a network and subsequently establishes two different NAS connections, one carrying NAS session management procedures and another carrying NAS UE policy management procedures. In this example, the call flow involves the UE, two core NFs, NF1 and NF2, and security key management function (SKMF) which is analogous to security anchor function (SEAF) in 5G.

At step 1, the primary AKA procedure is executed which establishes in both the UE and the SKMF an anchor key and a set of NAS parent keys.

At step 2, the UE requests establishment of NAS Connection #1 by sending a NAS connection request #1 message, for instance an initial NAS Session Management (SM) Request, which is routed to NF1. Since NF1 does not have a valid security context for NAS Connection #1, it requests a key from the SKMF e.g. by sending a key request.

At step 3, based on information provided in the key request from NF1, the SKMF may either select an already derived NAS parent key specific to NAS SM procedures or alternatively derive a NAS child key from the selected NAS parent key, and returns the NAS parent key or the NAS child key to NF1 e.g. in a key response.

At step 4, NF1 uses the received key to further derive NAS integrity and encryption keys to be used with selected NAS integrity and encryption algorithms to secure NAS Connection #1. NF1 sends a NAS security mode command message towards the UE.

At step 5, based on the NAS security mode command message received from NF1, the UE may either select an already derived NAS parent key specific to NAS SM procedures or alternatively derive a NAS child key from the selected NAS parent key, and use the NAS parent key or the NAS child key to further derive NAS integrity and encryption keys as derived at NF1. The UE populates the complete NAS connection request #1 message into a NAS security mode complete message, secures the NAS security mode complete message with the NAS integrity and encryption keys and sends the encrypted and integrity protected NAS security mode complete message to NF1.

At step 6, NF1 uses its NAS integrity and encryption keys to perform security checks on the received NAS security mode complete message, extracts the complete NAS connection request #1 message, processes it and returns a NAS connection response #1 to the UE. At this point, a security context is established between the UE and NF1 for NAS Connection #1 using the derived NAS integrity and encryption keys and the selected NAS integrity and encryption algorithms.

At step 7, the UE requests establishment of NAS Connection #2 by sending NAS connection request #2 message, for instance an initial NAS UE Policy Request, which is routed to NF2. Since NF2 does not have a valid security context for this NAS connection, it requests a key from the SKMF by sending a key request to the SKMF.

At step 8, based on information provided in the key request from NF2, the SKMF may either select an already derived NAS parent key specific to NAS UE policy management procedures or alternatively derive a NAS child key from the selected NAS parent key, and returns the NAS parent key or the NAS child key to NF2.

At step 9, NF2 uses the received key to further derive NAS integrity and encryption keys to be used with selected NAS integrity and encryption algorithms to secure the NAS Connection #2. NF2 sends a NAS security mode command message towards the UE.

At step 10, based on the NAS security mode command message received from NF2, the UE may either select an already derived NAS parent key specific to NAS UE policy management procedures or alternatively derive a NAS child key from the selected NAS parent key, and use the NAS parent key or the NAS child key to further derive NAS integrity and encryption keys as derived at NF2. The UE populates the complete NAS connection request #2 message into a NAS security mode complete message, secures the NAS security mode complete message with the NAS integrity and encryption keys and sends the encrypted and integrity protected NAS security mode complete message to NF2.

At step 11, NF2 uses its NAS integrity and encryption keys to perform security checks on the received NAS security mode complete message, extracts the complete NAS connection request #2 message, processes it and returns a NAS connection response #2 to the UE. At this point, a security context is established between the UE and NF2 for NAS Connection #2 using the derived NAS integrity and encryption keys and the selected NAS integrity and encryption algorithms.

Subsequent NAS message exchanges related to NAS Connection #1 and NAS Connection #2 are protected by their respective security contexts which survive idle-connected mode transition and hence avoid the need to rerun the NAS security mode command procedures.

Embodiments of the present disclosure will provide the following novel aspects:
NAS parent key, NAS parent key identifier (KI) and how they are derived and used;
NAS child key, NAS child key identifier and how they are derived, distributed and used;
HASH concept
enhancement of NAS security mode command (SMC) procedure to support new parameters
enhancement of SEAF functionality to support NAS parent/child Key derivation and distribution as an independent NF i.e., SKMF;
enhancement of UE functionality to support NAS parent/child Key derivation, enhanced NAS SMC procedures considering new temporary identifier (e.g. MM-GUTI (mobility management-globally unique temporary identifier) or its shorten version MM-S-TMSI (mobility management-short-temporary mobile subscriber identity), SM-GUTI (session management-globally unique temporary identifier)/SM-S-TMSI etc.) handling for multiple NAS terminations;
enhancement of the key hierarchy in network and UE;
enhancement of NFs to support NAS termination and support enhanced SMC procedures, HASH parameter setting/generation, key request procedures, UE capabilities request procedure;
new key management service based interfaces and procedures (Request/Response, Subscribe/Notify) for inter NF communications, e.g. NF-NF and NF-SKMF communications. Services include key derivation requests, new key derivation notifications (AKA run), authentication requests, and UE registered requests;
enhancement of the primary authentication procedure to include NAS parent key derivation and optionally NAS parent key identifiers derivation;
newly defined initial NAS messages and minimum mandatory Information Elements.

Some aspects described herein may leverage and extend the following functionalities and procedures in 3GPP specifications such as:
The NAS security mode command procedure as defined in 3GPP TS 33.501;
The key hierarchy defined in 3GPP TS 33.501;
The NAS container used in N2 handovers in 3GPP TS 33.501.
Authentication Procedures as defined in 3GPP TS 33.501
It should also be noted that the specification numbers for 6G System and security are not known at the time of this publication.

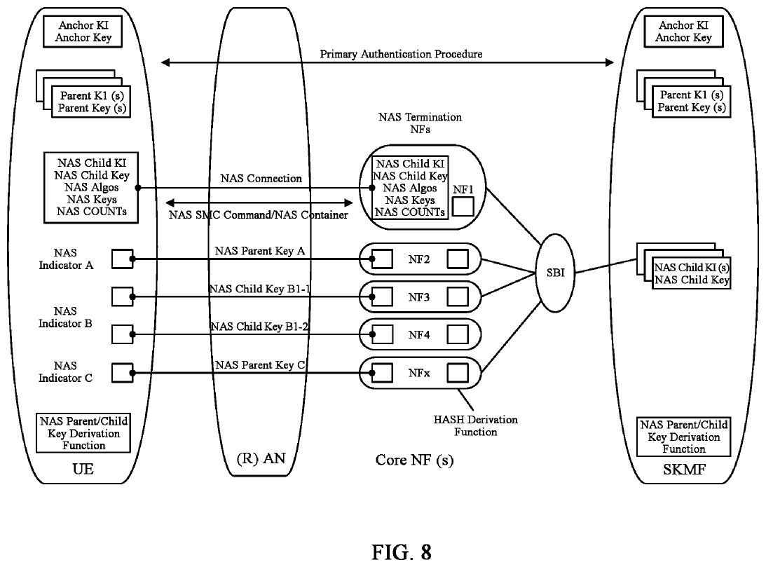

FIG. 8 illustrates a security architecture for the distributed NAS terminations architecture according to some embodiments of the present disclosure. As shown in FIG. 8, the security architecture involves the UE, multiple core NFs, and the SKMF.

On the network side, the SKMF in the serving network supports the derivation and management of the anchor/NAS parent/NAS child keys and key identifiers (KIs). The SKMF is proposed to encompass and extend the currently defined SEAF functionality to additionally support a set of standardized services that would enable the core NF(s) to obtain NAS parent/child keys and key identifiers as well as subscribe to and receive notifications when new security keys are derived, e.g. new anchor/NAS parent Keys derived as a result of a successful primary AKA run.

In terms of deployments, the SKMF may be:
Option 1: deployed as a standalone SKMF in a centralized location exposing its services via service-based interfaces (SBI) and services. As a standalone deployment, it provides flexibility in terms of deployment location, security, performance and scalability;
Option 2: co-located with a core NF handling NAS mobility management procedure. This option may potentially bring optimizations in terms of signaling load.

Defining a set of key management services and exposing these via SBI provides the greatest flexibility and enables deployment choices.

In some embodiments, the core NFs can terminate NAS connection(s), and store and manage for each NAS connection the NAS security context which includes the anchor key identifier, the NAS parent key identifier, the NAS child key, the NAS child key identifier, NAS algorithms, NAS Integrity and Encryption Keys, and NAS counts. The core NFs also can support HASH derivation function which is responsible for defining input parameters and derivation of a HASH value that is provided to the UE and the SKMF to derive the NAS child key. The core NFs can also support the NAS security mode command procedures and NAS container processing (during N2 handovers).

Further, in some embodiments, the core NF that terminate NAS mobility management procedures will only ever have a single NAS connection per access type at any point in time per UE. These core NFs are also responsible for derivation and distribution of access stratum (AS) specific keying material as currently defined in 3GPP TS33.501, e.g. KgNB, NCC, NH, KN3IWF.

In some embodiments, the UE may only have a single NAS connection for NAS mobility management procedures per access type at any point in time, and may concurrently have zero, one or more NAS connections for non-NAS mobility management procedures. In other words, the NAS connections for non-NAS mobility management procedures may only exist when there is already a NAS connection for NAS mobility management procedures established.

The UE functionality can be extended to support the NAS parent/child key and key identifier derivation and management as well as extensions to the AKA procedure and NAS SMC/NAS container related procedures.

The following will explain some concepts mentioned in the embodiments of the present disclosure.

### 1. NAS Indicator

When NAS connections are terminated across different types of core NFs depending on the NAS procedure that a NAS connection carries, it is assumed that the UE provides a NAS indicator (with standardized values) in order to indicate the NAS procedure that is carried. For example, a NAS connection carrying NAS mobility management procedures will be terminated at a core NF that supports NAS mobility management procedures, a NAS connection carrying NAS session management procedures will be terminated at a core NF that supports NAS session management procedures.

In some embodiments, the NAS indicator can be defined and standardized, and its values will indicate the NAS procedures supported. For example:
NAS indicator value “MM”=NAS mobility management procedures;
NAS indicator value “SM”=NAS session management procedures;
NAS indicator value “SMS”=NAS short message service (SMS) management procedures;
NAS indicator value “UEP”=NAS UE policy management procedures, etc.
   In some embodiments, all the values of the NAS indicator are inherently known by the UE and the network.

In some embodiments, the NAS indicator may be carried in NAS messages to identify the NAS procedure and can be used to make decisions about NF selection and security key derivations. The NAS indicator is also provided and visible to lower layers (e.g. radio resource control (RRC)) to enable access nodes to make decision on NF discovery and selection.

In some embodiments, the NAS indicator may also be included in NF profiles to support to enable discovery and selection of the correct NF from network repository function (NRF) for example.

### 2. Security Key Hierarchy, Derivation and Distribution

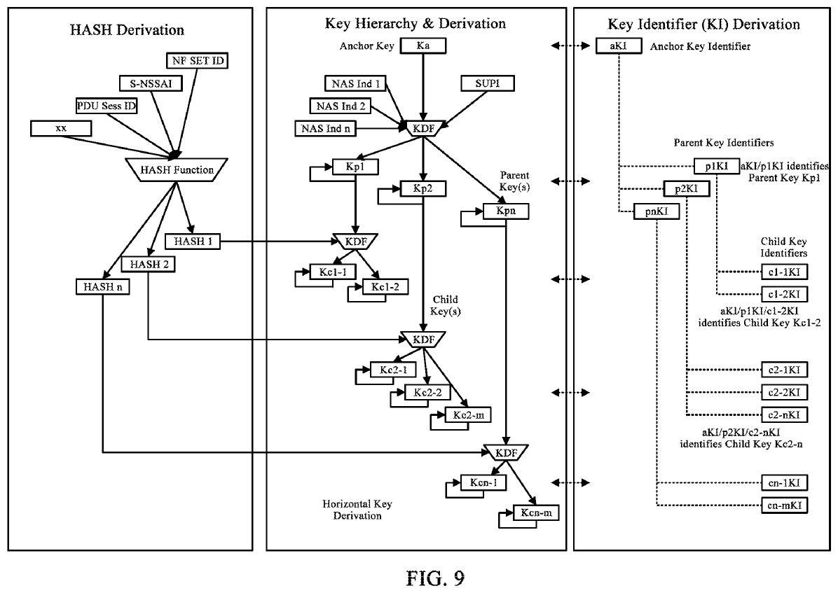

FIG. 9 illustrates a security framework for the distributed NAS terminations architecture according to some embodiments of the present disclosure. For this security framework, it introduces the following concepts:
Anchor key and anchor key identifier;
NAS parent key and NAS parent key identifier;
NAS child key and NAS child key identifier;
HASH value.

### 2.1 Anchor Key and Anchor Key Identifier

Anchor key and anchor key identifier can provide an anchor with which the security for the distributed NAS terminations architecture is built. The anchor key and anchor key identifier are analogous to Kseaf and ngKSI respectively used in 5G with the same AKA procedures having some extensions/enhancements.

### 2.2 NAS Parent Key and NAS Parent Key Identifier

A NAS parent key may be derived independently by the UE and the SKMF from an anchor key, a Subscription Permanent Identifier (SUPI) and a NAS indicator. A NAS parent key identifier is associated with a NAS parent key and can be derived independently by the UE and the SKMF.

The purpose of the NAS parent key is to provide a shared secret key that is unique to NAS connections carrying the same type of NAS procedures. For example, a NAS connection carrying NAS mobility management procedures may have a NAS parent key that is different from a NAS connection that is carrying NAS session management procedures and so on.

In some embodiments, a new NAS parent key may also be horizontally derived by the UE and the SKMF, for example during N2 handovers, by using as input the current NAS parent key and a NAS count value. In this case the new NAS parent key is identified by the existing NAS parent key identifier of the old NAS parent key.

In some embodiments, the value of a NAS parent key identifier may be the same as the NAS indicator value used to derive that NAS parent key. Since all NAS indicator values are standardized and hence known to both the UE and the SKMF, this ensures that both the UE and the SKMF can derive the same NAS parent key identifiers for the NAS parent keys they derive respectively.

An alternative approach to the generation of the NAS parent key identifier is that the SKMF can assign a unique value for each NAS parent key identifier and provide this value and the associated NAS indicator to the UE during the AKA procedure. This approach can allow the serving network to control the NAS parent key identifier values and remove the requirement to derive the NAS parent key identifiers from the UE.

### 2.3 NAS Child Key and NAS Child Key Identifier

In some embodiments, a NAS child key may be derived independently by the UE and the SKMF from a NAS parent key and a HASH value.

The purpose of the NAS child key is to provide shared secret keys that are unique for NAS connections carrying the same type of NAS procedures. It is needed when a single type of NAS connection can be terminated in multiple core NF instances. For example, a NAS connection carrying NAS session management procedures may have two NAS PDU sessions, one terminated in the core NF instance processing SM of slice 1 and the other terminated in the core NF instance processing SM to slice 2. The NAS child keys can be derived which are unique to both slice 1 and slice 2.

In some embodiments, a NAS child key identifier, which is associated to a specific NAS child key, may be derived in the SKMF and subsequently provided to the UE during a NAS SMC procedure or in a NAS container during N2 handovers.

In order for the UE to derive a NAS child key, the following information is provided to the UE by the network:
an anchor key identifier to check that it is associated with a current and valid AKA run;
an anchor key identifier and a NAS parent key identifier to identify the NAS parent key;
a HASH value to be used with the NAS parent key to derive the NAS child key;
a NAS child key identifier which is assigned to the derived NAS child key.

In some embodiments, a new NAS child key may also be horizontally derived by the UE and the SKMF, for example during N2 handovers, by using as input the current NAS child key and a NAS count value. In this case, the new NAS child key can be identified by the existing NAS child key identifier of the old NAS child key.

To identify a specific key, a single or multiple key identifiers may be needed. For example, to identify an anchor key, only the anchor key identifier is needed. To identify a NAS parent key, the anchor key identifier and the NAS parent key identifier are needed. And to identify a NAS child key, the anchor key identifier, the NAS parent key identifier and the NAS child key identifier are needed.

### 2.4 HASH Value

The purpose of the HASH value is to provide separation of the NAS child keys. A HASH value is a value that is derived by a core NF from a specific set of input parameters that the core NF can be configured to select from and provided to the UE and the SKMF. Each core NF may use the same or different sets of input parameters to derive the HASH value. The UE and the SKMF are agnostic to how the HASH value is derived, which provides flexibility in the mechanism(s) used to derive the HASH value.

In some embodiments, such input parameters can be single network slice selection assistance information (S-NSSAI), a PDU session ID, a NF set ID, etc. The parameters used to generate the HASH value can be configured by the network and hence can be specific to the serving network operator. The HASH value can be communicated to the UE as part of an enhanced NAS security mode command procedure in order to enable the UE to derive the NAS child key.

Depending on how the HASH value is derived, a NAS child key may be used to secure a single NAS connection or multiple NAS connections of the same NAS procedures group. For instance, if the HASH value is derived based on a UE's PDU session ID, then the NAS child key derived from that HASH value will only apply to a NAS connection that carries that PDU session ID. On the other hand, if the HASH value is derived based on a S-NSSAI, then the NAS child key derived from that HASH value will be common across the NAS connections associated with that S-NSSAI. In this latter case, even though the NAS child key returned from the SKMF to each core NF will be the same, the NAS child key identifiers for the NAS child keys will be unique between different NFs. The reason for this is that even though the NAS child keys are the same initially when assigned by the SKMF, each NF may independently execute a horizontal key derivation of its NAS child key which will result in new NAS child keys being derived and hence unique from each other, and in order for the UE to be able to distinguish these NAS child keys, they need to have a unique NAS child key identifier.

If a HASH value is derived from a combination of a PDU session ID and a S-NSSAI, then the NAS child key derived from that HASH value would be dedicated to a specific NAS connection associated with that PDU session within that S-NSSAI. The HASH value and the NAS child key/identifier concepts provide a powerful, flexible and extensible mechanism to dynamically derive security keys based on security requirements.

In order for a UE to obtain services from a network, the UE must first register with the network, whereby by the UE and the network mutually authenticate each other, and if successful the UE is authorized to use the services offered by the network based on its subscription. As part of the registration procedure, the UE performs the AKA procedure which results in the UE and the network deriving the anchor Key. Subsequently, the NAS parent keys are also independently derived in the UE and the SKMF from the anchor Key, SUPI and NAS indicator(s).

The mechanism by which a security context is established between a UE and the network for a NAS connection in general follows a common procedure. First, the core NF receiving the initial NAS message will create a HASH value, and send a request to the SKMF to derive a NAS child key. If successful, the SKMF will return the derived NAS child key and NAS child key identifier to the core NF. The core NF will use the same HASH value and the received NAS child key to generate security parameters to be used in a NAS security mode command procedure towards the UE. Receipt of the NAS security mode command procedure triggers the UE to derive a NAS child key and assign the NAS child identifier received from the core NF to it. If successful, both the UE and the core NF will have the same NAS child key and NAS child key identifiers which are used in conjunction with agreed NAS integrity and encryption algorithms to integrity protect and cipher the NAS connection between the UE and the core NF.

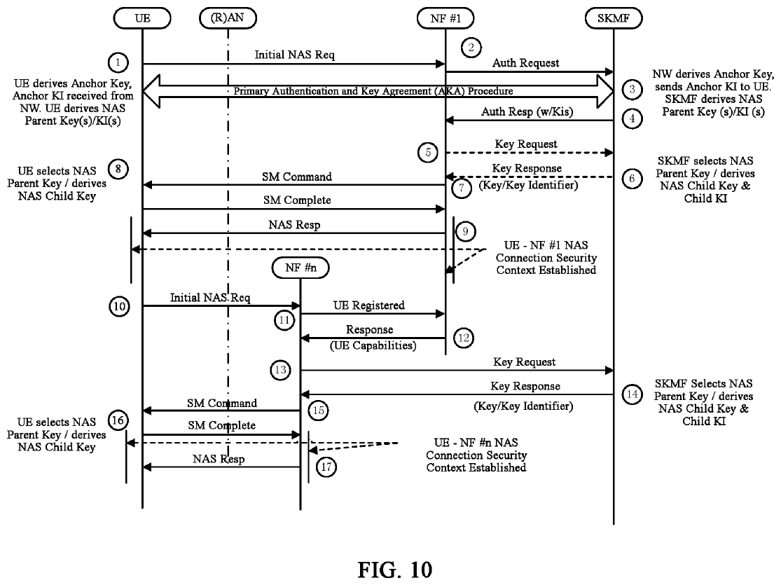

FIG. 10 is another exemplary call flow for securing multiple NAS connections according to some embodiments of the present disclosure, which describes a scenario where the UE registers with the network and establishes a NAS connection for NAS mobility management procedures and subsequently requests another NAS connection for NAS session management procedures. This call flow explains how these NAS connections are protected.

At step 1, the UE initiates a registration request with a selected network and sends an initial NAS message (e.g. NAS MM Registration Request) in the clear, i.e. not security protected, with the minimum mandatory Information Elements (e.g. Subscription Concealed Identifier (SUCI)/temporary ID, UE security capabilities, anchor key identifier, NAS indicator) to enable the network to process the request. The UE also provides the NAS indicator and derived temporary identifier (MM-GUTI) to the lower layers (e.g. RRC) to enable the (R)AN to make decisions on the discovery and selection of a suitable core NF for this NAS Procedure. In this example, NF #1 is selected. The value of the NAS indicator will indicate NAS mobility management procedures.

At step 2, NF #1 determines based on the received NAS registration request that UE authentication is required because, for example, the anchor key identifier indicates that a valid anchor key does not exist, or the SUCI is received, or the temporary identifier is invalid or not found. Then NF #1 sends an authentication request to the SKMF which includes the SUCI, Serving Network Id, and the NAS indicator.

At step 3, the SKMF triggers the primary AKA procedure with the UE, which if successful results in the follows:
The UE and the SKMF independently derive and store an anchor key;
The SKMF derives and stores an anchor key identifier that identifies the anchor key and provides it to the UE which stores it;
Independently, the UE and the SKMF will each derive NAS parent keys using the anchor key and standardized NAS indicator values for key separation and store them.
Independently, the UE and the SKMF will each derive NAS Parent Key Identifier(s) using the Anchor Key Identifier and standardized NAS Indicator Values for identifier separation and store them.
After the NAS parent keys and the NAS parent identifiers are derived and stored, the anchor key is deleted from the UE and the SKMF, and the anchor key identifier remains in both UE and SKMF.
   Note: The AKA procedure needs enhancement to accommodate the NAS parent key and NAS parent key identifiers derivation.

At step 4, the SKMF returns an authentication response to NF #1 which contains the anchor key identifier and the NAS parent key identifier associated with the NAS indicator provided in the authentication request.

At step 5, NF #1 sends a key request for this NAS connection to the SKMF containing the received anchor key identifier, NAS parent key identifier and optionally a HASH value. NF #1 may use pre-configured information and the information provided by the UE to determine what parameters (e.g. S-NSSAI-x, NF SET-ID etc.) are used as input to generate the HASH value.

In some scenarios, the NAS child key is beneficial to MM procedures (e.g. mobility from one MM function to another, dual registration with MM functions in parallel). However, in other scenarios, the NAS child key could be considered optional. In this call flow, it assumes the need for the NAS child key for illustrative purpose, but it is not mandated for MM procedures with distributed NAS terminations.

At step 6, the SKMF uses the anchor key identifier to check that it is associated with a current and valid AKA run, and uses the anchor key identifier and the NAS parent key identifier to identify the NAS parent key. If the HASH value is received, the SKMF may use it and the NAS parent key to derive a NAS child key and a NAS child key identifier. Then, the SKMF may return to NF #1 the derived NAS child key, the NAS child key identifier and the NAS parent key identifier, if the HASH value is received. If the HASH value is not received, the SKMF may return to NF #1 the identified NAS parent key.

In some embodiments, the signaling between NF #1 and the SKMF can be optimized. Here, NF #1 refers to any NF that handles NAS mobility management procedures.

In some embodiments, the key request and response messages between NF #1 and the SKMF can be removed. The authentication request message can implicitly trigger the SKMF to return in the authentication response certain keys and associated key identifiers to NF #1 which would optimize the signaling load by removing the explicit key request/response message.

This can be achieved as follow:
The SKMF implicitly determines the NAS indicator associated with an authentication request as it is always associated with a NAS mobility management procedure which will have its own standardized NAS indicator value, i.e., no need to include the NAS indicator in the authentication request;
The SKMF uses the NAS indicator to derive the NAS parent key from the anchor key and SUPI;
The SKMF derives the NAS parent key identifier as normal, e.g. using a NAS indicator value;
The SKMF returns the NAS parent key and NAS parent key identifier in the authentication response to NF #1, if no HASH value is provided;
If a NAS child key is required, then the authentication request could contain the HASH value which would allow the SKMF to derive and return the NAS child key and NAS child key identifier to NF #1.

In some embodiments, NF #1 and the SMKF can be co-located. NF #1 and the SKMF can be deployed as co-located as a single NF, meaning interactions between them are internal to the NF.

In some embodiments, if the SKMF is deployed as a standalone NF, the AKA procedures it executes towards the UE may be indirect via NF #1 or direct by-passing NF #1.

At step 7, from a configured and prioritized list of supported NAS integrity and encryption algorithms, NF #1 selects the highest priority NAS integrity and encryption algorithms supported by the UE based on UE security capabilities received in Step 1. NF #1 uses the selected NAS integrity and encryption algorithms identifiers and the NAS child key or NAS parent key received from the SKMF to derive a NAS integrity key and a NAS encryption key.

NF #1 creates and sends a NAS security mode command message to the UE and starts a NAS downlink (DL) count for this NAS connection which is initialized to zero. The NAS security mode command message may contain the anchor key identifier, the NAS parent key identifier, the NAS child key identifier, the HASH value, the UE security capabilities, the selected NAS integrity and encryption algorithms, a flag requesting the complete initial NAS message (e.g. NAS Registration Request) to be returned in the NAS security mode complete message. The NAS security mode command message is integrity protected by the NAS integrity key.

Further, NF #1 may store in its NAS security context for this NAS connection the following information: the anchor key identifier, the NAS parent key identifier, the NAS child key identifier, the NAS child key, the HASH value, the UE security capabilities, the selected NAS integrity and encryption algorithms, the NAS integrity and encryption keys and NAS UL/DL counts.

At step 8, from the received NAS security mode command message, the UE may use the anchor key identifier to check that it is associated with a current and valid AKA run, and use the anchor key identifier and the NAS parent key identifier to identify the NAS parent key. If the HASH value and the NAS child key identifier are received, the UE may use the HASH value and the NAS parent key to derive a NAS child key, and assign the received NAS child key identifier to the derived NAS child key. Then the UE may use either the NAS parent key or the NAS child key and selected NAS integrity and encryption algorithms identifiers to derive the NAS integrity and encryption keys. Further, the UE may use the NAS integrity key and the NAS integrity algorithm to check the integrity of the received NAS security mode command message. Also, the UE may check the UE security capabilities to ensure bidding down attack has not occurred.

If all the checks pass, the UE may generate a NAS security mode complete message which includes the complete registration request (which is triggered by the flag received in NAS security mode command message). Then the UE may encrypt and integrity protect the NAS security mode complete message with the selected NAS integrity and encryption algorithms and the NAS integrity and encryption keys. The UE may also prepare an NAS uplink (UL) counter initialized to zero for this NAS connection. Then the UE sends the NAS security mode complete message to NF #1.

Further, the UE may store in its NAS security context for this NAS connection the following information: the anchor key identifier, the NAS parent key identifier, the NAS child key identifier, the NAS child key, the HASH value, the UE security capabilities, the selected NAS integrity and encryption algorithms, the NAS integrity and encryption keys, and NAS UL/DL counts.

At step 9, NF #1 integrity checks and deciphers the received NAS security mode complete message using the selected NAS integrity and encryption algorithms and the NAS integrity and encryption keys. If successful, the newly received complete initial NAS message (e.g. NAS Registration Request) is processed and a NAS registration response is returned to the UE containing a UE temporary context identifier (MM-GUTI) for this NAS Connection.

The MM-GUTI (or its shorten version MM-S-TMSI) identifier uniquely identifies a UE's MM context within an NF and the NF itself. A UE MM context contains, among other information, the NAS security context for a UE's MM NAS connections. Note that, the MM part of MM-GUTI/MM-S-TMSI indicates that the context is related to a mobility management procedure (which registration is a part of). A UE context for a NAS session management (SM) procedure may be identified by SM-GUTI/SM-S-TMSI.

For subsequent NAS mobility management procedures related to this NAS connection, the NAS messages will contain the MM-GUTI/MM-S-TMSI temporary identifier to enable identification of the serving NF and the UE context stored within that NF.

All subsequent NAS messages for this NAS connection between the UE and NF #1 are integrity protected and encrypted using the common security parameters/keys stored in the NAS security contexts stored in both the UE and NF #1.

At step 10, subsequent to successful network registration, the UE may initiate a new NAS connection, for example to initiate establishment of a PDU session using NAS session management procedures. Similar to step 1, the initial NAS message is sent in the clear with the minimum mandatory Information Elements to enable the network process the request, and the (R)AN will use the NAS indicator, MM-GUTI/MM-S-TMSI, S-NSSAI-y parameters provided by the UE to the lower layers to assist in the selection of a suitable core NF to process NAS session management procedures. In this case, the NAS indicator will show that the request is for NAS session management procedures and the (R)AN will select a core NF that supports those procedures. In this example, the core NF is NF #n. The mechanism by which the (R)AN can select a suitable core NF may include using the NAS indicator as a lookup key in a locally configured table of NFs or querying a network repository function (NRF).

In an embodiment, the initial NAS message for NAS session management procedures can include: the MM-GUTI, the anchor key identifier, the NAS parent key identifier associated with the NAS indicator for NAS session management procedures, and the NAS indicator.

At step 11, NF #n may use the received MM-GUTI/MM-S-TMSI to confirm that the UE is successfully registered with the network by sending a request to NF #1 which is identified from the MM-GUTI/MM-S-TMSI parameter. The MM-GUTI/MM-S-TMSI can be provided to NF #1 in order to identify the UE context that NF #1 has stored for the UE.

At step 12, if the UE is confirmed as successfully registered, NF #1 may return a success response which also includes the UE security capabilities to NF #n.

At step 13, NF #n sends a key request for this NAS connection to the SKMF containing the received anchor key identifier, the NAS parent key identifier and optionally a HASH value. In an embodiment, NF #n may use pre-configured information and the information provided by the UE to determine what parameters (e.g. S-NSSAI-y, NF SET-ID etc.) are used as input to generate the HASH value.

At step 14, the SKMF uses the anchor key identifier to check that it is associated with a current and valid AKA run, and uses the anchor key identifier and the NAS parent key identifier to identify the NAS parent key. If the HASH value is received, the SKMF may use it and the NAS parent key to derive a NAS child key and a NAS child key identifier. Then, the SKMF may return to NF #n the derived NAS child key, the NAS child key identifier and the NAS parent key identifier, if the HASH value is received. If the HASH value is not received, the SKMF may return to NF #n the identified NAS parent key.

At step 15, from a configured and prioritized list of supported NAS integrity and encryption algorithms, NF #n may select the highest priority NAS integrity and encryption algorithms supported by the UE based on the received UE security capabilities. NF #n uses the selected NAS integrity and encryption algorithms identifiers and the NAS child key or NAS parent key received from the SKMF to derive a NAS integrity key and a NAS encryption key.

Then NF #n may create and send a NAS security mode command message to the UE and starts a NAS DL count for this NAS connection which is initialized to zero. The NAS security mode command message may contain the anchor key identifier, the NAS parent key identifier, the NAS child key identifier, the HASH value, the UE security capabilities, the selected NAS integrity and encryption algorithms, a flag requesting the complete initial NAS message (e.g. NAS PDU session request) to be sent in the NAS security mode complete message. The NAS security mode command message is integrity protected by the NAS integrity key.

Further, NF #n may store in its NAS security context for this NAS connection the following information: the anchor key identifier, the NAS parent key identifier, the NAS child key identifier, the NAS child key, the HASH value, the UE security capabilities, the selected NAS integrity and encryption algorithms, the NAS integrity and encryption keys and NAS UL/DL counts.

At step 16, from the received NAS security mode command message, the UE may use the anchor key identifier to check that it is associated with a current and valid AKA run, and use the anchor key identifier and the NAS parent key identifier to identify the NAS parent key. If the HASH value and the NAS child key identifier are received, the UE may use the HASH value and the NAS parent key to derive a NAS child key, and assign the received NAS child key identifier to the derived NAS child key. Then the UE may use either the NAS parent key or the NAS child key and selected NAS integrity and encryption algorithms identifiers to derive the NAS integrity and encryption keys. Further, the UE may use the NAS integrity key and the NAS integrity algorithm to check the integrity of the received NAS security mode command message. Also, the UE may check the UE security capabilities to ensure bidding down attack has not occurred.

If all the checks pass, the UE may generate a NAS security mode complete message which includes the complete initial NAS message (e.g. NAS PDU session request), which is triggered by the flag received in NAS security mode command message. Then the UE may encrypt and integrity protect the NAS security mode complete message with the selected NAS integrity and encryption algorithms and the NAS integrity and encryption keys. The UE may also prepare an NAS uplink (UL) counter initialized to zero for this NAS connection. Then the UE sends the NAS security mode complete message to NF #n.

Further, the UE may store in its NAS security context for this NAS connection the following information: the anchor key identifier, the NAS parent key identifier, the NAS child key identifier, the NAS child key, the HASH value, the UE security capabilities, the selected NAS integrity and encryption algorithms, the NAS integrity and encryption keys, and NAS UL/DL counts.

At step 17, NF #n integrity checks and deciphers the received NAS security mode complete message using the selected NAS integrity and encryption algorithms and the NAS integrity and encryption keys. If successful, the newly received complete initial NAS message (e.g. NAS PDU session request) is processed and a NAS PDU session response is returned to the UE containing a UE temporary context identifier (SM-GUTI) for this NAS Connection.

The SM-GUTI (or its shorten version SM-S-TMSI) identifier uniquely identifies a UE's SM context in terms of the NF it is located on and the UE SM context within that NF. A UE SM context contains, among other information, the NAS security context for a UE's SM NAS connections. Note that, the SM part of SM-GUTI/SM-S-TMSI indicates that the context is related to a NAS session management procedure.

For subsequent NAS PDU session management procedures on this NAS connection, the NAS messages will contain the SM-GUTI/SM-S-TMSI temporary identifier to enable identification of the serving NF and the UE context stored within that NF.

All subsequent NAS messages for this NAS connection between the UE and NF #n are integrity protected and encrypted using the common security parameters/keys stored in the NAS security contexts stored in both the UE and NF #n.

Note that the NAS child key and NAS child key identifier and the HASH value are primarily required where there is a need for key separation between NAS connections that are handling the same NAS procedures, e.g. two or more NAS connections handling NAS SM procedures. Where such key separation is not required, for instance a single NAS connection for NAS MM procedures, the NAS parent key and NAS parent key identifier may be used. If there are two NAS connections handling the same NAS procedures, then the NAS parent key and NAS parent key identifier cannot be used and the NAS child key and NAS child key identifier must be used.

When a NAS child key and NAS child key identifier are not used, i.e., the NAS parent key and NAS parent key identifier are used to secure a NAS connection, the HASH value, the NAS child key and NAS child key identifiers are not derived/distributed in the UE and the network. The decision whether a NAS child key and NAS child key identifier are derived or not depends on configuration of the core NF terminating the NAS connection. If the core NF is configured to provide a HASH value to the SKMF/UE for key derivation, a NAS child key and NAS child key identifier are derived and used, otherwise no NAS child key and NAS child key identifier is derived and the NAS parent key and NAS parent key identifier are used instead.

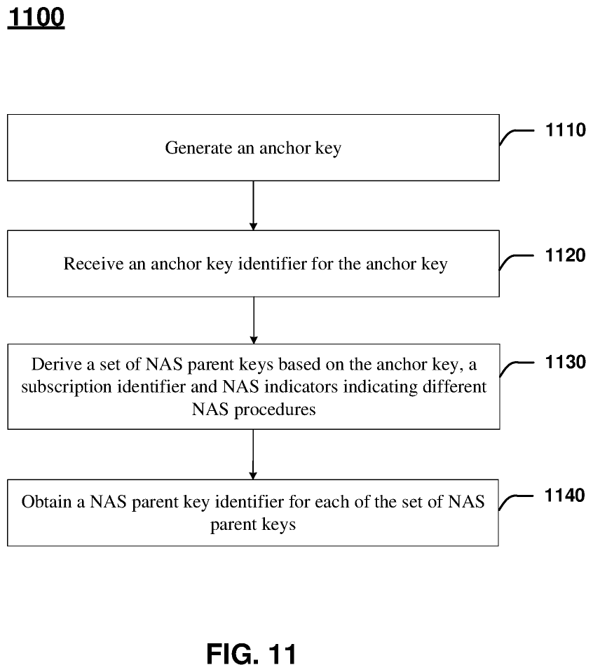

More details of the example embodiments in accordance with the present disclosure will be described with reference to FIG. 11 to FIG. 13.

FIG. 11 is a flow chart depicting a method 1100 for security in the distributed NAS terminations architecture according to some embodiments of the present disclosure. The method 1100 may be performed by a terminal device such as a UE for handling security of multiple NAS connections in the distributed NAS terminations architecture.

As shown in FIG. 11, the terminal device generates an anchor key e.g. with a network entity configured to implement security key management function (SKMF) (hereinafter referred to as SKMF entity, which can be used interchangeably with SKMF herein), at block 1110. In some embodiments, the terminal device and the SKMF entity may perform a primary AKA procedure to generate the anchor key.

At block 1120, the terminal device receives an anchor key identifier for the anchor key from the SKMF entity. As mentioned above, the anchor key identifier can be used to identify the anchor key.

At block 1130, the terminal device derives a set of NAS parent keys based on the anchor key, a subscription identifier and NAS indicators indicating different NAS procedures. In some embodiments, the subscription identifier may be SUPI. As mentioned above, the NAS indicator may have different values for indicating different NAS procedures. Thus, the terminal device can obtain multiple NAS parent keys based on the anchor key, the subscription identifier (e.g. SUPI) and different values of the NAS indicator.

Then at block 1140, the terminal device obtains a NAS parent key identifier for each of the set of NAS parent keys. In some embodiments, the terminal device may derive the NAS parent key identifier for the NAS parent key based on the NAS indicator on which that the NAS parent key is derived. In some embodiments, the NAS parent key identifiers associated with the NAS parent keys may be received from the SKMF entity, and thus the terminal device does not need to derive the NAS parent key identifiers.

In some embodiments, the NAS parent key identifier associated with a NAS parent key may have the same value as the NAS indicator based on which the NAS parent key is derived. In some embodiments, the NAS parent key identifier may be assigned a unique value by the SKMF entity.

Thus, a NAS parent key can be identified by a combination of the anchor key identifier and the NAS parent key identifier.

Additionally, in some embodiments, the terminal device may store the anchor key identifier, the NAS parent keys and the associated NAS parent key identifiers. Further, the anchor key may be removed from the terminal device.

Additionally, in some embodiments, the terminal device may request establishment of a first NAS connection carrying a first NAS procedure between the terminal device and a first core network entity which is configured to implement a core network function. As used herein, term “core network entity” and “core network function” can be used interchangeably. In some embodiments, the terminal device may send a first NAS connection request to the first core network entity which implements a core network function. In some embodiments, the first NAS connection request may comprise the anchor key identifier and the NAS indicator indicating the first NAS procedure, among other information. In an embodiment, the first NAS connection request may be an initial NAS message, e.g. NAS mobility management registration request, and the first NAS procedure may be NAS mobility management procedures, and thus the first core network entity may be an NF supporting mobility management procedures.

Then the terminal device may determine a NAS key for the first NAS connection based on security related information associated with the first NAS procedure from the first core network entity. In some embodiment, the security related information may be received in a NAS security mode command message. In some embodiments, the security related information may include the anchor key identifier, the NAS parent key identifier, UE security capabilities, selected NAS integrity and encryption algorithms, and a flag requesting a complete initial NAS message to be sent. In this case, the terminal device may identify the NAS parent key based on the anchor key identifier and the NAS parent key identifier, and determine the NAS key to be the identified NAS parent key as no HASH value is provided. In some embodiments, the security related information may further include the HASH value and the NAS child key identifier. In this case, after identifying the NAS parent key, the terminal device may derive a NAS child key based on the identified NAS parent key and the HASH value, and assign the received NAS child key identifier to the NAS child key. Then the NAS child key is determined as the NAS key for the first NAS connection. The NAS child key can be identified by a combination of the anchor key identifier, the NAS parent key identifier and the NAS child key identifier.

Further, in some embodiments, the terminal device may derive NAS integrity and encryption keys based on the NAS key and the selected NAS integrity and encryption algorithms, and generate a NAS security mode complete message including the complete initial NAS message. Then the terminal device may encrypt and integrity protect the NAS security mode complete message and send it to the first core network entity. Further, in some embodiments, the terminal device may store a NAS security context for the first NAS connection. The NAS security context may include the anchor key identifier, the NAS parent key identifier, the NAS child key identifier, the NAS child key, the HASH value, security capabilities of the terminal device, selected NAS integrity and encryption algorithms, the NAS integrity and encryption keys, and NAS counts. Further, the terminal device may receive a temporary context identifier for the first NAS connection from the first core network entity. The temporary context identifier can be used to identify the NAS security context of the terminal device within the first core network entity and the first core network entity itself.

Alternatively, in some embodiments, the terminal device may (re)generate the anchor key after the request for establishment of the first NAS connection from the first core network entity.

Additionally, in some embodiments, the terminal device may request establishment of a second NAS connection carrying a second NAS procedure between the terminal device and a second core network entity. In some embodiments, the terminal device may send a second NAS connection request to the second core network entity. In some embodiments, the second NAS connection request may comprise the anchor key identifier and the NAS indicator indicating the second NAS procedure, among other information. In an embodiment, the second NAS connection request may also be an initial NAS message, e.g. a NAS PDU session request, and the second NAS procedure may be NAS session management procedures, and the second core network entity may be an NF supporting session management procedures.

Then the terminal device may determine a NAS key for the second NAS connection based on security related information associated with the second NAS procedure received from the second core network entity. In some embodiments, the security related information may be included in a NAS security mode command message. In some embodiments, the security related information associated with the second NAS procedure message may include the anchor key identifier, the NAS parent key identifier, UE security capabilities, selected NAS integrity and encryption algorithms, and a flag requesting a complete initial NAS message to be sent. In this case, the terminal device may identify the NAS parent key based on the anchor key identifier and the NAS parent key identifier, and determine the NAS key to be the identified NAS parent key as no HASH value is provided. In some embodiments, the security related information associated with the second NAS procedure may further include the HASH value and the NAS child key identifier. In this case, after identifying the NAS parent key, the terminal device may derive a NAS child key based on the identified NAS parent key and the HASH value, and assign the received NAS child key identifier to the NAS child key. Then the NAS child key is determined as the NAS key for the second NAS connection.

Further, in some embodiments, the terminal device may derive NAS integrity and encryption keys based on the NAS key and the selected NAS integrity and encryption algorithms, and generate a NAS security mode complete message including the complete initial NAS message. Then the terminal device may encrypt and integrity protect the NAS security mode complete message and send it to the second core network entity. Further, in some embodiments, the terminal device may store a NAS security context for the second NAS connection. Further, the terminal device may receive the temporary context identifier for the second NAS connection from the first core network entity.

Although only two NAS connections carrying different NAS procedures are given as an example to explain the method 1100, those skilled in the art will appreciate that the method 1100 can be applicable to more than two NAS connections.

Additionally, in some embodiments, the first NAS procedure and the second NAS procedure are the same NAS procedure or different NAS procedures, and the first core network function is different from the second core network function. Note that, if the first NAS procedure is NAS mobility management procedures, the second NAS procedure can only be non-NAS mobility management procedures. The first NAS procedure and the second NAS procedure can be the same non-NAS mobility management procedures.

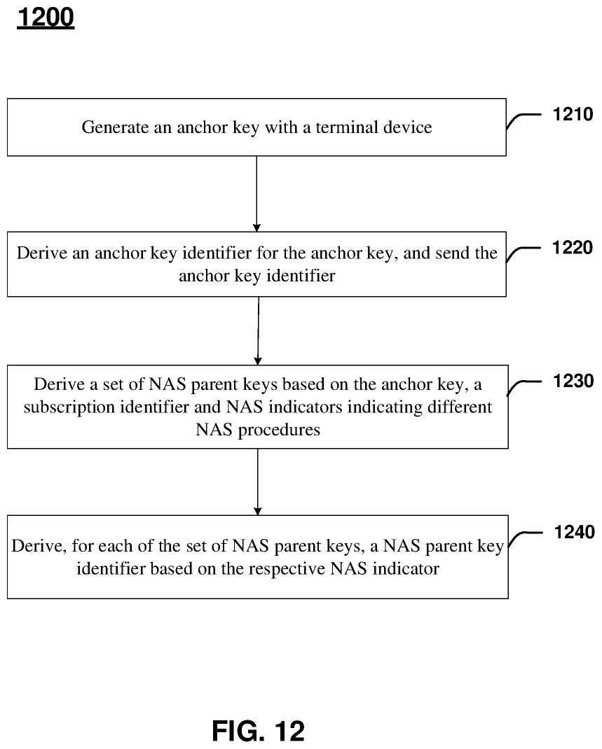

FIG. 12 is a flow chart depicting a method 1200 for security in the distributed NAS terminations architecture according to some embodiments of the present disclosure. The method 1200 may be performed by the SKMF entity.

As shown in FIG. 12, the SKMF entity may generate an anchor key with a terminal device, e.g. the UE in the distributed NAS terminations architecture, at block 1210. In some embodiments, the SKMF entity and the terminal device may perform a primary AKA procedure to generate the anchor key.

At block 1220, the SKMF entity may derive an anchor key identifier for the anchor key, and send the anchor key identifier to the terminal device. Then at block 1230, the SKMF entity may derive a set of NAS parent keys based on the anchor key, a subscription identifier and NAS indicators indicating different NAS procedure. In some embodiments, the subscription identifier may be SUPI. As mentioned above, the NAS indicator may have different values for indicating different NAS procedures. Thus, the SKMF entity can obtain multiple NAS parent keys based on the anchor key, the subscription identifier (e.g. SUPI) and different values of the NAS indicator.

At block 1240, the SKMF entity may derive, for each of the set of NAS parent keys, a NAS parent key identifier based on the respective NAS indicator. Thus, the NAS parent key can be identified by a combination of the anchor key identifier and the NAS parent key identifier. In some embodiments, the NAS parent key identifier associated with a NAS parent key may have the same value as the NAS indicator based on which the NAS parent key is derived.

Alternatively or additionally, in some embodiments, the SKMF entity may send the NAS parent key identifiers to the terminal device, such that the terminal device may not derive the NAS parent key identifiers itself. Alternatively, in some embodiments, the SKMF entity may assign the NAS parent key identifier with a unique value, and send the NAS parent key identifier with the value and the associated NAS indicator to the terminal device.

Additionally, in some embodiments, the SKMF entity may store the anchor key identifier, the NAS parent keys and the associated NAS parent key identifiers. Further, the anchor key may be removed from the SKMF entity.

Additionally, in some embodiments, the SKMF entity may receive, from a first core network entity, a first request for a NAS key for a first NAS connection carrying a first NAS procedure. Then the SKMF entity may determine the NAS key for the first NAS connection based on the first request, and send the NAS key for the first NAS connection to the first core network entity.

In some embodiments, the first request may comprise the anchor key identifier and the NAS parent key identifier. In this case, the SKMF entity may determine the NAS key by identifying the NAS parent key based on the anchor key identifier and the NAS parent key identifier received in the first request, and determining the NAS key to be the identified NAS parent key as no HASH value is provided. Then the SKMF entity may send the identified NAS parent key to the first core network entity.

Alternatively, in some embodiments, the first request may comprise the HASH value in addition to the anchor key identifier and the NAS parent key identifier. In this case, the SKMF entity may determine the NAS key by: identifying the NAS parent key based on the anchor key identifier and the NAS parent key identifier, deriving a NAS child key based on the identified NAS parent key and the HASH value, deriving a NAS child key identifier for the NAS child key, and determine the NAS key to be the derived NAS child key. Then the SKMF entity may send the NAS child key, the NAS child key identifier and the NAS parent key identifier to the first core network entity.

In some embodiment, the first request may be a key request, and the NAS key and related information (if any) may be included in a key response to be sent to the first core network entity.

Alternatively, in some embodiments, the generation of the anchor key by the SKMF entity may be triggered upon receipt of an authentication request from the first core network entity. The authentication request can be based on a request from the terminal device for establishment of a first NAS connection carrying a first NAS procedure between the terminal device and the first core network entity, and may comprise the NAS indicator indicating the first NAS procedure, among other information. In this case, the SKMF entity may derive the NAS parent key associated with the first NAS procedure based on the anchor key, the subscription identifier (e.g. SUPI), and the NAS indicator included in the authentication request, and derive the NAS parent key identifier for the NAS parent key. Then the SKMF entity may send the anchor key identifier and the NAS parent key identifier in an authentication response to the first core network entity.

Alternatively or additionally, in some embodiments, the SKMF entity may determine the NAS key for the first NAS connection based on the authentication request. In some embodiments, the authentication request may further comprise the HASH value. In this case, the SKMF entity may further derive a NAS child key based on the derived NAS parent key and the HASH value, derive a NAS child key identifier for the NAS child key, and determine the NAS key for the first NAS connection to be the NAS child key. Then the SKMF entity may send the derived NAS child key, the NAS child key identifier and the NAS parent key identifier to the first core network entity. In some embodiments, the authentication request does not include the HASH value. In this case, the SKMF entity may determine the NAS key as the derived NAS parent key associated with the first NAS procedure, and send the NAS parent key and the NAS parent key identifier to the first core network entity.

Additionally, in some embodiments, the first core network entity may be configured to handle NAS mobility management procedures, and the network entity and the first core network entity may be co-located.

Additionally, in some embodiments, the SKMF entity may receive, from a second core network entity, a second request for a NAS key for a second NAS connection carrying a second NAS procedure. Then the SKMF entity may determine the NAS key for the second NAS connection based on the second request, and send the NAS key for the second NAS connection to the second core network entity. The SKMF entity may process the second request in a same way as the first request, and thus the description about the processing of the second request is omitted here.

Although only two NAS connections carrying different NAS procedures are given as an example to explain the method 1200, those skilled in the art will appreciate that the method 1200 can be applicable to more than two NAS connections.

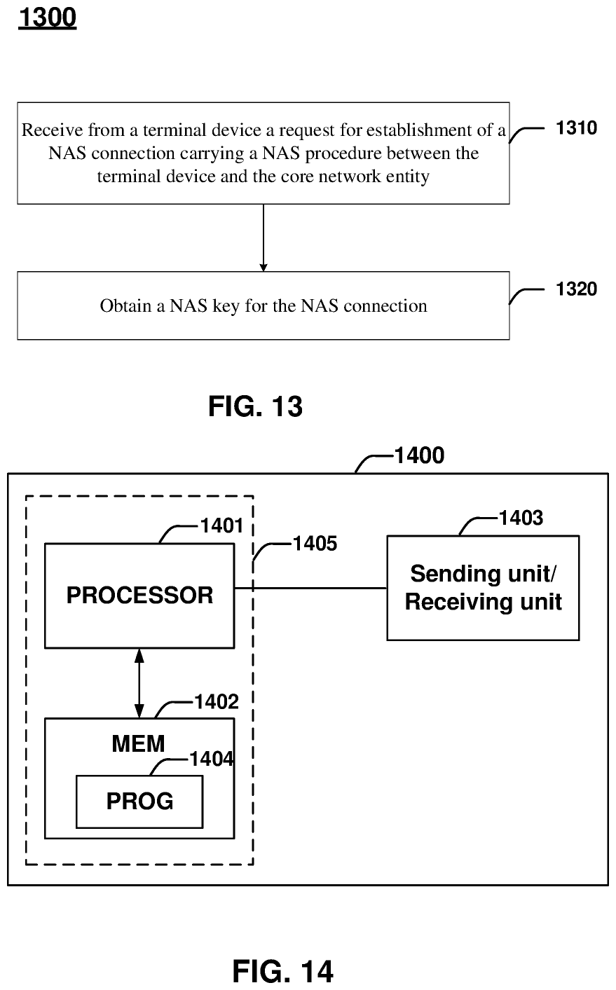

FIG. 13 is a flow chart depicting a method 1300 for security in the distributed NAS terminations architecture according to some embodiments of the present disclosure. The method 1300 may be performed by a core network entity configured to implement a core network function, e.g. a NF supporting mobility management procedures, or session management procedures, or policy management procedures, etc.

As shown in FIG. 13, the core network entity may receive from a terminal device a request for establishment of a NAS connection carrying a NAS procedure between the terminal device and the core network entity, at block 1310. The terminal device may be the UE in the distributed NAS terminations architecture. In some embodiments, the request may be an initial NAS message, e.g. NAS MM registration request, or NAS PDU session request, and accordingly the NAS procedure may be NAS mobility management procedures or NAS session management procedures.

At block 1320, the core network entity may obtain a NAS key for the NAS connection e.g. from a network entity configured to implement SKMF, e.g. the SKMF entity as described above. The NAS key may be a NAS parent key or a NAS child key associated with a NAS indicator indicating the NAS procedure.

In some embodiments, the core network entity may determine whether an authentication for the terminal device is required based on the request for establishment of the NAS connection. In some embodiments, the request may comprise SUCI or the temporary context ID (e.g. MM-GUTI/MM-S-TMSI), UE security capabilities, the anchor key identifier and the NAS indicator which indicates the NAS procedure. The authentication may be determined to be required, if the anchor key identifier indicates that a valid anchor key does not exist, or the SUCI is included in the request, or the temporary context ID is invalid or not found. Otherwise, it is determined that the authentication is not required.

If it is determined that the authentication is required, the core network entity may send an authentication request to the SKMF entity. The authentication request may comprise the NAS indicator indicating the NAS procedure, among other information. Then the core network entity may receive an anchor key identifier and a NAS parent key identifier associated with the NAS indicator, e.g. in an authentication response. The core network entity may trigger to send a request for the NAS key to the SKMF entity, wherein the request comprises the received anchor key identifier and the NAS parent key identifier. In some embodiments, the request may be a key request. When the request does not comprise the HASH value, the core network entity may receive the NAS parent key identified by the anchor key identifier and the NAS parent key identifier as the NAS key from the SKMF entity. When the request further comprises the HASH value, the core network entity may receive the NAS child key based on the anchor key identifier, the NAS parent key identifier and the HASH value as the NAS key, a NAS child key identifier for the NAS child key, and the NAS parent key identifier.

Alternatively, in some embodiments, when it is determined that the authentication is required, the core network entity may trigger to send an authentication request to the SKMF entity, and the authentication request may comprise the NAS indicator indicating the NAS procedure and optionally the HASH value, among other information. In the case that the authentication request does not comprise the HASH value, the core network entity may receive the NAS parent key identified by the anchor key identifier and the NAS parent key identifier as the NAS key from the SKMF entity. In the case that the authentication request further comprises the HASH value, the core network entity may receive the NAS child key associated with the NAS indicator as the NAS key, a NAS child key identifier for the NAS child key, and the NAS parent key identifier associated with the NAS parent key based on which the NAS child key is derived.

Additionally, in some embodiments, if it is determined that the authentication is not required, the core network entity may verify whether the terminal device is successfully registered. In some embodiments, the core network entity may send a request to another core network entity which is identified by the received MM-GUTI/MM-S-TMSI to verify. If the terminal device is verified as successfully registered, the core network entity may receive a success response from the other core network entity. Then the core network entity may send a request for the NAS key to the SKMF entity, e.g. a key request. This request may comprise an anchor key identifier and a NAS parent key identifier and optionally a HASH value. In the case that the request does not comprise the HASH value, the core network entity may receive the NAS parent key identified by the anchor key identifier and the NAS parent key identifier as the NAS key from the SKMF entity. In the case that the request further comprises the HASH value, the core network entity may receive the NAS child key based on the anchor key identifier, the NAS parent key identifier and the HASH value as the NAS key, a NAS child key identifier for the NAS child key, and the NAS parent key identifier from the SKMF entity.

Additionally, in some embodiments, the core network entity may generate a HASH value based on at least one of the following: a PDU session ID; S-NSSAI; and a network function set identifier.

Additionally, the core network entity may be configured to handle NAS mobility management procedures, and the core network entity and the SKMF entity may be co-located.

The above-described various embodiments of the present disclosure can ensure that the NAS connections terminated at different core NFs are secure, resilient and little risk due to any potential attack is minimized. In addition, the solutions of these embodiments are optimal and performance efficient.

The following will present some additional aspects/embodiments of the present disclosure.

### 1. Handling of Access Stratum (AS) Keys.

A UE may have multiple concurrent NAS connections terminated in the serving network. Each NAS connection may be associated with a NAS indicator, and the same NAS indicator may be used in more than one NAS connection depending on the value of the NAS indicator. For instance, the NAS indicator for NAS session management procedures may be used in multiple concurrent NAS connections in the case where the UE has multiple NAS PDU sessions across different S-NSSAIs for example. However, the NAS indicator for NAS mobility management procedures may only be used in a single NAS connection per access type (3GPP access or non-3GPP access) at any given time for the UE. That is, there cannot be multiple active NAS connections using the NAS indicator for NAS mobility management procedures actively concurrent for 3GPP access for example.

In some embodiments, the NAS parent key associated with a NAS connection for NAS mobility management procedures can be used as input to derive AS keys by the UE and the core NF. The NAS child keys that are associated with NAS connections for non-NAS mobility management procedures may not be used to derive AS keys.

In some embodiments, the core NFs that terminate the NAS connections for NAS mobility management procedures may use their NAS parent key to derive and distribute AS keys in the same manner as AMF uses the Kamf key and other parameters (e.g. NAS count, NCC) as input to derive and distribute AS keys (e.g. K_{gNB}, NH, K_{N3IWF}) as defined in TS 33.501. The UE may use its NAS parent key associated with NAS mobility management procedures to derive AS keys in the same manner as the UE uses the Kamf key and other parameters (e.g. NAS count, NCC) as input to derive AS keys (e.g. K_{gNB}, NH, K_{N3IWF}) as defined in TS 33.501.

Derivation of new NAS child/parent key associated with NAS mobility management procedures may also trigger the derivation of new AS keys.

### 2. NAS Connections Over 3GPP Access and Non-3GPP Access

Leveraging and building upon TS 33.501 Section 6.4.2.2, when a UE has two NAS connections supporting the same NAS procedures, one over 3GPP access and the other over non-3GPP access, and both terminating at the core NFs in the same PLMN, then the UE and the core NFs will maintain, as part of their respective NAS security contexts, NAS counts and NAS connection identifier (3GPP/non-3GPP) for each NAS connection. Other NAS security context parameters will be shared across both NAS connections, such as the NAS integrity and encryption keys and the NAS integrity and encryption algorithms. When a UE has two NAS connections supporting the same NAS procedures, one over 3GPP access and the other over non-3GPP access, and both terminating at the core NFs in different PLMNs, then the UE and the core NFs will maintain, as part of their respective NAS security contexts, a complete set of security parameters for each NAS connection including the NAS counts, NAS connection identifier (3GPP/non-3GPP), the NAS integrity and encryption keys and the NAS integrity and encryption algorithms.

### 3. Initial NAS Message and Idle to Connected Mode Transition Handling

The handing of initial NAS messages according to 3GPP TS 33.501, section 6.4.6 and idle to connected mode transition according to 3GPP 33.501, section 6.8.1.2.1 is leveraged and extended.

In the case where the UE has a valid NAS security context, the UE provides in the initial NAS message the minimum mandatory Information Elements (e.g. SUCI/temporary ID/MM-S-TMSI/SM-S-TMSI, UE security capabilities, anchor key identifier, NAS parent key identifier, NAS child key identifier, NAS indicator in the clear as well as the complete NAS message encrypted and the entire initial NAS message integrity protected using its NAS security context.

If the core NF has the same NAS security context, then it integrity checks the initial NAS message, and decrypts the complete NAS message received, processes it and secures the response with the NAS security context. If the core NF does not have or cannot obtain a valid NAS security context, then it can request to trigger an AKA procedure run to derive a new anchor key etc. If the core NF is handling NAS mobility management procedures, then it sends an authentication request to the SKMF. If the core NF is handling non-NAS mobility management procedures, then it sends a request to the NF that is handling NAS mobility management procedures which will in turn trigger the AKA procedure towards the SKMF.

If the AKA run is successful, the core NF handling NAS mobility management procedures will trigger a NAS security mode command towards the UE to established a NAS security context for the NAS connection as explained previously with reference to FIG. 7 and FIG. 10.

### 4. N2 Handover

In an N2 handover, a target NF may select different NAS integrity and encryption algorithms from those used by a source NF, and the source NF may provide the target NF with a new NAS child or parent key, depending which is used, and as such these changes need to be reflected in the UE's NAS security context.

During the N2 handover, the principles defined in 3GPP TS33.501, Section 6.9.2.3.3 can be leveraged and extended. Triggered by receipt of a handover required message, the source NF may provide the anchor key identifier, NAS parent key identifier, NAS child key identifier, UE security capabilities, NAS DL count, NAS child/parent key and an indication if the NAS Child/parent key has been horizontally derived to the target NF. The NAS security context of a NAS connection secured using a NAS parent key has the NAS parent key and NAS parent key identifier, but does not have a NAS child key nor NAS child key identifier. The NAS security context of a NAS connection secured using a NAS child key has a NAS parent key, a NAS parent key identifier, the NAS child key and a NAS child key identifier.

The decision to perform horizontal key derivation of a NAS parent key or a NAS child key may be determined by the presence or absence of a NAS child key identifier. If the NAS child key identifier is present, then the horizontal key derivation of the NAS child key occurs, and if the NAS child key identifier is missing, then the horizontal key derivation of the NAS parent key occurs.

Similarly, the target NF may decide whether to use the NAS parent key or the NAS child key to derive the NAS integrity and encryption keys based on the presence or absence of a NAS child key. If the NAS child key is present, then it is used to derive the NAS integrity and encryption keys, otherwise the NAS parent key is used.

According to local policy configuration, the source NF may decide if the horizontal key derivation is performed. The source NF may perform the horizontal derivation of NAS child/parent key using the current active NAS child/parent key and the NAS DL count as inputs, so as to derive a new NAS child/parent key. The source NF may send these inputs in a request for horizonal key derivation to the SKMF which returns the new horizontally derived NAS child/parent key.

Based on the UE security capabilities which indicate the supported NAS integrity and encryption algorithms, the target NF may select from its supported NAS integrity and encryption algorithms the highest prioritized ones and uses these NAS integrity and encryption algorithm identifiers as input, along with the NAS child/parent key, to derive NAS integrity and encryption keys. The target NF may store in its NAS security context the anchor key identifier, NAS parent key identifier, NAS child key identifier, NAS child/parent key, NAS integrity and encryption keys, UE security capabilities, NAS DL count, and NAS integrity and encryption algorithms.

The target NF may create a NAS container with security parameters, which is integrity protected with the NAS integrity key and provided via (R)AN to the UE. The purpose of the NAS container can be considered similar to the NAS security mode command. The NAS container may contain the anchor key identifier, NAS parent key identifier, NAS child key identifier, UE security capabilities, NAS DL count, selected NAS integrity and encryption algorithms and an indication if the NAS child/parent key has been horizontally derived.

From its locally stored NAS security context, the UE may use the anchor key identifier to check that it is associated with a current and valid AKA run, use the anchor key identifier and NAS parent key identifier to identify the NAS parent key, and use the anchor key identifier, the NAS parent key identifier and the NAS child key identifier to identify the NAS child key. If the horizontal key derivation is indicated, the UE may use the locally identified NAS child/parent key and the received NAS DL count to horizontally derive a new NAS child/parent key which is associated with the existing NAS child/parent key identifier.

The NAS integrity and encryption algorithms identifiers and the new NAS child/parent key can be used as inputs to derive the NAS integrity and encryption keys. The NAS integrity key may be used to check the integrity of the received NAS container, and the received UE security capabilities may be checked to ensure that a bidding down attack has not occurred.

If the NAS integrity check passed, then the UE's NAS security context may be updated with the new NAS child/parent/keys, the new NAS integrity and encryption keys and NAS counts. Note as per TS33.501, Section 6.9.2.3.3, if the NAS child/parent key is horizontally derived, the NAS counts are set to zero, otherwise the received NAS count is used.

The above procedure is mainly referring to mobility management function relocation scenario, but this can be extended and made applicable for any NF that could be relocated as part of UE mobility.

### 5. Xn Handover

The NF anchoring the NAS mobility management connection can be responsible for providing the target RAN with the keying material as defined in 3GPP TS33.501, Section 6.9.2.3.2 where the Kamf is equivalent to the NAS child/parent key.

### 6. Idle Mode Mobility Registration Updates

When a target NF receives a NAS mobility registration update, it may use the temporary identifier (e.g. MM-GUTI/MM-S-TMSI) to identify the source NF storing the UE's context which includes the UE NAS security context. If the source NF finds a valid UE context, it may provide the target NF with the SUPI and may provide its stored NAS security context information.

During the NAS mobility registration update, the principles defined in 3GPP TS 33.501, Section 6.9.3 can be leveraged and extended.

According to local policy configuration, the source NF may decide if horizontal key derivation is performed. The source NF may perform the horizontal derivation of NAS child/parent key using the current active NAS child/parent key and the NAS UL count of the received NAS registration request (mobility update) as inputs to derive a new NAS child/parent key. The source NF may send these inputs in a request for horizonal key derivation to the SKMF which returns the new horizontally derived NAS child/parent key.

The source NF may provide the UE NAS security context information to the target NF which includes the anchor key identifier, NAS parent key identifier, NAS child key identifier, UE security capabilities, NAS UL count, NAS child/parent key and an indication if the NAS child/parent key has been horizontally derived.

Based on the UE security capabilities which indicate the supported NAS integrity and encryption algorithms, the target NF may select from its supported NAS integrity and encryption algorithms the highest prioritized ones and uses these NAS integrity and encryption algorithm identifiers as inputs, along with the NAS child/parent key, to derive NAS integrity and encryption keys.

The target NF may store in its NAS security context the anchor key identifier, NAS parent key identifier, NAS child key identifier, NAS child/parent key, NAS integrity and encryption keys, UE security capabilities, NAS UL count, and NAS integrity and encryption algorithms.

According to local policy configuration, the target NF may decide if a NAS child/parent key including a horizontally derived one from the source NF is used or not. If not, the target NF may trigger a re-authentication procedure which can derive new anchor key, anchor key identifier, NAS parent key identifier, NAS child key identifier, NAS child/parent key, and establish a new NAS security context with the UE.

If the NAS security context information from the source NF is used, the target NF may create and send to the UE a NAS security mode command message which is integrity protected with the NAS integrity key and includes anchor key identifier, NAS parent key identifier, NAS child key identifier, UE security capabilities, selected NAS integrity and encryption algorithms and an indication if the NAS child/parent key has been horizontally derived.

From its locally stored NAS security context, the UE may use the anchor key identifier to check that it is associated with a current and valid AKA run, use the anchor key identifier and the NAS parent key identifier to identify the NAS parent key, and use the anchor key identifier, the NAS parent key identifier and the NAS child key identifier to identify the NAS child key. If the horizontal key derivation is indicated, the UE may use the locally identified NAS child/parent key and the NAS UL count of the NAS registration request to horizontally derive a new NAS child/parent key.

The NAS integrity and encryption algorithms identifiers and the new NAS child/parent key may be used as inputs to derive the NAS integrity and encryption keys. The NAS integrity key may be used to check the integrity of the received NAS security mode command, and the received UE security capabilities may be used to ensure that a bidding down attack has not occurred.

If the NAS integrity check passes, then the UE may update its NAS security context with the new NAS child/parent Key, the new NAS integrity and encryption keys, NAS integrity and encryption algorithms and NAS counts, and returns a NAS security mode complete to the target NF.

Now reference is made to FIG. 14 illustrating a simplified block diagram of an apparatus 1400 that may be embodied as the terminal device, or the network entity configured to implement SKMF, or the core network entity configured to implement a core NF. The apparatus 1400 may comprise at least one processor 1401, such as a data processor (DP) and at least one memory (MEM) 1402 coupled to the at least one processor 1401. The apparatus 1400 may further comprise a sending unit and a receiving unit 1403 coupled to the one or more processors 1401.

The processors 1401 may be of any type suitable to the local technical environment, and may include one or more of the following: general purpose computers, special purpose computers, microprocessors, digital signal processors (DSPs) and processors based on multicore processor architecture, as non-limiting examples.

The MEM(s) 1402 may be of any type suitable to the local technical environment and may be implemented using any suitable data storage technology, such as semiconductor-based memory devices, magnetic memory devices and systems, optical memory devices and systems, fixed memory and removable memory, as non-limiting examples.

The MEM 1402 stores a program (PROG) 1404. The PROG 1404 may include instructions that, when executed on the associated processor 1401, enable the apparatus 1400 to operate in accordance with the embodiments of the present disclosure, for example to perform one of the methods 1100, 1200 and 1300 as shown in FIG. 11, FIG. 12 and FIG. 13. A combination of the at least one processor 1401 and the at least one MEM 1402 may form processing circuitry or means 1405 adapted to implement various embodiments of the present disclosure.

Various embodiments of the present disclosure may be implemented by a computer program executable by one or more of the processors 1401, software, firmware, hardware or in a combination thereof.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosures may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosures may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium, for example, non-transitory computer readable medium, such as a hard disk, optical disk, removable storage media, solid state memory, RAM, etc. As will be appreciated by one of skills in the art, the function of the program modules may be combined or distributed as desired in various embodiments. In addition, the function may be embodied in whole or in part in firmware or hardware equivalents such as integrated circuits, field programmable gate arrays (FPGA), and the like.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1-70. (canceled)

71. A terminal device, comprising:
at least one processor; and
at least one memory storing instructions that, when executed by the at least one processor, cause the terminal device at least to:
generate an anchor key;
receive an anchor key identifier for the anchor key;
derive a set of non-access stratum, NAS, parent keys based on the anchor key, a subscription identifier and NAS indicators indicating different NAS procedures; and
obtain, for each of the set of NAS parent keys, a NAS parent key identifier.

72. The terminal device according to claim 71, wherein to obtain, for each of the set of NAS parent keys, a NAS parent key identifier, the terminal device is caused to derive, for each of the set of NAS parent keys, the NAS parent key identifier based on the respective NAS indicator.

73. The terminal device according to claim 71, wherein to obtain, for each of the set of NAS parent keys, a NAS parent key identifier, the terminal device is caused to:
receive the NAS parent key identifiers associated with the NAS parent keys.

74. The terminal device according to claim 71, wherein the terminal device is further caused to:
store the anchor key identifier, the set of NAS parent keys and the respective NAS parent key identifiers.

75. The terminal device according to claim 71, wherein the NAS parent key identifier associated with a NAS parent key has the same value as the NAS indicator based on which the NAS parent key is derived.

76. The terminal device according to claim 71, wherein the terminal device is further caused to:
request establishment of a first NAS connection carrying a first NAS procedure between the terminal device and a first core network entity; and
determine a NAS key for the first NAS connection based on security related information associated with the first NAS procedure from the first core network entity.

77. The terminal device according to claim 76, wherein to request establishment of the first NAS connection carrying the first NAS procedure between the terminal device and the first core network entity, the terminal device is caused to:
send, to the first core network entity, a first NAS connection request which comprises the anchor key identifier and the NAS indicator indicating the first NAS procedure.

78. The terminal device according to claim 76, wherein to determine the NAS key for the first NAS connection, the terminal device is caused to:
identify the NAS parent key based on the anchor key identifier and the NAS parent key identifier included in the security related information associated with the first NAS procedure;
determine, when the security related information does not comprise a HASH value, the NAS key to be the identified NAS parent key;
when the security related information comprises a HASH value,
derive a NAS child key based on the identified NAS parent key and the HASH value;
assign a NAS child key identifier included in the security related information associated with the first NAS procedure to the derived NAS child key; and
determine the NAS key to be the derived NAS child key.

79. The terminal device according to claim 76, wherein the generation of the anchor key is performed after the request for establishment of the first NAS connection.

80. The terminal device according to claim 76, wherein the terminal device is further caused to:
derive a new NAS key for the first NAS connection based on the current NAS key for the first NAS connection and NAS counts during a handover or during a NAS registration update.

81. The terminal device according to claim 76, wherein the terminal device is further caused to:
request establishment of a second NAS connection carrying a second NAS procedure between the terminal device and a second core network entity; and
determine a NAS key for the second NAS connection based on security related information associated with the second NAS procedure from the second core network entity.

82. The terminal device according to claim 81, wherein to request establishment of the second NAS connection carrying the second NAS procedure between the terminal device and the second core network entity, the terminal device is caused to:
send, to the second core network entity, a second NAS connection request which comprises the anchor key identifier and the NAS indicator indicating the second NAS procedure.

83. The terminal device according to claim 81, wherein to determine the NAS key for the second NAS connection, the terminal device is caused to:
identify the NAS parent key based on the anchor key identifier and the NAS parent key identifier included in the security related information associated with the second NAS procedure;
determine, when the security related information associated with the second NAS procedure does not comprise a HASH value, the NAS key to be the identified NAS parent key;
when the security related information associated with the second NAS procedure comprises a HASH value,
derive a NAS child key based on the identified NAS parent key and the HASH value;
assign a NAS child key identifier included in the security related information associated with the second NAS procedure to the derived NAS child key; and
determine the NAS key to be the derived NAS child key.

84. The terminal device according to any of claim 81, wherein the terminal device is further caused to:
derive a new NAS key for the second NAS connection based on the current NAS key for the second NAS connection and NAS counts during a handover or during a NAS registration update.

85. The terminal device according to claim 81, wherein the first NAS procedure and the second NAS procedure are the same NAS procedure or different NAS procedures.

86. The terminal device according to claim 76, wherein the terminal device is further caused to derive access stratum, AS, keys based at least in part on the NAS key for the NAS connection carrying NAS mobility management procedures.

87. A network entity configured to implement security key management function, comprising:
at least one processor; and
at least one memory storing instructions that, when executed on the at least one processor, cause the network entity to:
generate an anchor key with a terminal device;
derive an anchor key identifier for the anchor key, and send the anchor key identifier to the terminal device;
derive a set of non-access stratum, NAS, parent keys based on the anchor key, a subscription identifier and NAS indicators indicating different NAS procedures; and
derive, for each of the set of NAS parent keys, a NAS parent key identifier based on the respective NAS indicator.

88. A core network entity configured to implement a core network function, comprising:
at least one processor; and
at least one memory storing instructions that, when executed by the at least one processor, cause the core network entity at least to:
receive from a terminal device a request for establishment of a NAS connection carrying a NAS procedure between the terminal device and the core network entity; and
obtain a NAS key for the NAS connection, wherein the NAS key is a NAS parent key or a NAS child key associated with a NAS indicator indicating the NAS procedure.
